(19) United States
(12) Patent Application Publication
(10) Pub. No.: US 2010/0030577 A1
(43) Pub. Date: Feb. 4, 2010

(54) System and Business Method for Electrocardiogram Review

(75) Inventors: Larry W. Lawson, The Woodlands, TX (US); Paul Minardi, Montgomery, TX (US); Robert Jordan, The Woodlands, TX (US); Richard Woodyard, Montgomery, TX (US); James R. Dilger, JR., Houston, TX (US)

Correspondence Address: ANDREWS & KURTH, L.L.P., 600 TRAVIS, SUITE 4200, HOUSTON, TX, 77002, US

(73) Assignee: eCARDIO DIAGNOSTICS, LLP

(21) Appl. No.: 12/182,925

(22) Filed: Jul. 30, 2008

(51) Int. Cl. G06Q 50/00

(52) U.S. Cl. 705/3

(57) ABSTRACT

A system and method for review and analysis of electrocardiograms includes an application server computer system in communication with a plurality of client computers. In a preferred embodiment, the server computer provides notification and access of a patient cardiac study report to an electrocardiograph technician for review and comment. The technician assigns an academic fellow electrophysiologist to review the study report. The server computer provides notification and access of the study report and the technician's annotation to the assigned fellow for review and comment. The fellow then assigns an attending physician to review the study report. The server computer provides notification and access of the study report and the previous annotations to the attending physician for review and comment. The physician completes the study. The computer system automatically generates and forwards a referral letter to the requesting physician and attends to billing for the cardiac monitoring services.

### BACKGROUND OF THE INVENTION

1. Field of the Invention

This invention relates generally to business methods in the medical services industry and specifically to an improved system and business method for reviewing electrocardiograms.

2. Description of the Prior Art

An arrhythmia is an abnormality or disturbance in a person's heartbeat rate or rhythm. The condition may interfere with the heart's ability to pump blood throughout the body, signaling a higher risk for a future cardiac event. Arrhythmias can cause symptoms such as palpitations, lightheadedness, shortness of breath, dizziness, and syncope. An atrial or supraventricular arrhythmia occurs in the left or right atrium, and a ventricular arrhythmia in the left or right ventricle.

Physicians may diagnose or monitor arrhythmias using an electrocardiograph, a device which measures and records the heart's electrical impulses. The electrocardiograph typically generates an electrocardiogram (EKG), in which the channels of cardiac activity are plotted on paper, typically one above the other, as ordinates on a graph, with time as the abscissa. An electrocardiograph test is typically performed in a physician's office or a hospital by an EKG technician. Approximately 10 to 15 electrodes are taped to a person's chest, arms and legs. For a resting test, the patient lies down, and for a stress test, the patient walks on a treadmill. The electrocardiogram is then routed to a hospital attending physician qualified in electrophysiology, who analyzes and interprets the electrocardiogram and provides a written opinion for the referring physician to review.

An electrocardiograph test is beneficial to detect frequent or constant arrhythmic conditions, but many arrhythmias are of an intermittent nature which are less susceptible to detection by an ordinary electrocardiograph test, which records cardiac activity for only a short duration. To monitor infrequent arrhythmias, physicians typically use ambulatory cardiac monitors—portable electrocardiographs that typically record from one to seven channels of cardiac data and are worn by the patient for recording arrhythmic events while the patient is away from the physician's office. Ambulatory monitors typically fall in to one of two general types: Holter monitors and cardiac event recorders.

Holter monitors are worn for one or more days and record from two to seven channels continuously. Cardiac activity is recorded on a slow moving tape or computer disk. The monitor is battery operated and worn on a waist band or belt or in a carrying case slung over a shoulder. At the completion of the one to three day test, the “Holter tape” is extracted for reading cardiac data.

Event monitors, also known as loop recorders, are worn for an extended period, for example, thirty days or more. Like a Holter monitor, the event monitor continuously records cardiac activity, but the device memory is rewritten in a continuous loop so that only the cardiac activity for the past hour or so is available at any given instant. When the patient notes arrhythmic symptoms, the patient depresses a button on the event recorder that causes the recorder to permanently save the captured cardiac data for the period immediately preceding, during and following the arrhythmic event. That cardiac event data is later extracted for reading, for example by transmitting the cardiac data from the event recorder to a cardiac monitoring service facility over the telephone.

Holter monitors and event monitors are typically loaned to patients by cardiac monitoring service companies as part of monitoring service. Monitoring service companies supply monitors with blank tape or disks and fresh batteries, hook up supplies and instructional materials and may provide technicians to hook up the monitors to the patients. At the conclusion of the test, the monitoring service extracts and analyzes the recorder data, providing to the requesting physician run length summaries, waveform analyses, breakdowns, ST analyses, and selected EKG strips.

3. Identification of Features Provided by Embodiments of the Invention

A primary object of the invention is to provide improved review and analysis of electrocardiograms in a prompt manner by subjecting electrocardiograms to the scrutiny of academic fellow electrophysiologists (in addition to electrocardiograph technicians and attending physicians) using a structured electronic system that provides accessibility, instant communication between the reviewers, ensures responsiveness of the academician, and promotes financial accountability for the study.

A feature provided by one or more embodiments of the invention is the ability to quickly notify reviewers of new cardiac studies for review and to remind reviewers of incomplete and pending studies.

Another feature provided by one or more embodiments of the invention is the ability to sort and filter patient data by the severity of the patients' conditions.

Another feature provided by one or more embodiments of the invention is the ability to provide for real-time online enrollment of a patient into a cardiac monitoring program.

Another feature provided by one or more embodiments of the invention is the ability to automatically generate a referral letter based on a completed cardiac study report.

Another feature provided by one or more embodiments of the invention is the ability to automatically generate and provide billing information pertaining to cardiac monitoring services.

Another feature provided by one or more embodiments of the invention is an improvement in the accessibility of EKG strips for review and the ability to track the number of EKG strips that have been reviewed by an academic fellow electrophysiologist for fulfilling professional requirements.

### SUMMARY OF THE EMBODIMENTS OF THE INVENTION

The objects and features identified above, as well as other features of one or more embodiments of the invention are provided by a business method for the review of electrocardiograms (EKGs) implemented by a custom application server system that is arranged and designed to route cardiac data for review by first, an EKG technician, second, an academic fellow electrophysiologist, if used, and finally, an attending physician, for superior and more timely analyses of EKGs.

The application server system functions as a web-enabled software portal that is accessible by patients, referring physicians, EKG technicians, cardiac monitoring services, attending physicians, and academic fellows using client computers connected to the internet. In addition to providing access to EKGs and routing notifications, the system automatically generates written reports and correspondence and attends to billing and logistical matters related to EKG review.

The application server implements a preferred method for EKG review wherein a patient enrolls directly into the monitoring program using a client computer to access the application server computer system over the internet. The patient enters various personal and demographic information. An EKG technician prepares an electrocardiograph recorder for the monitoring period, configuring any custom parameters as required. Once the recorder is hooked up to the patient, the system automatically generates a client billing report and forwards it to the monitoring service provider's billing department for billing the patient and/or the patient's insurance provider for the initial monitor hook-up. The patient is then monitored, either outpatient or inpatient.

For the baseline EKG, if any, each cardiac episode recording, if any, and test end measurement, the cardio data are uploaded from the recorder to the application server and stored in a database. A cardiac monitoring service provider technician processes the raw cardio data and generates a cardiac study report. The system then notifies an EKG technician, for example, by e-mail, SMS text message, pager, et cetera, that a study report has been generated and requires review.

The EKG technician logs on to the application server computer system for access to patient study report. The EKG technician reviews the study report online and provides analytical comments, which are written to the database by the application server computer system. The comments of EKG technician remain available for viewing but not for editing by an academic fellow electrophysiologist and attending physician who subsequently review the study report.

Using the functionality provided by the server system, the EKG technician preferably assigns the study report to an academic fellow electrophysiologist for review. The server computer system then notifies the fellow via e-mail, SMS text message, pager, et cetera, that study report requires review. The system records the time until fellow reviews the report and automatically generates and sends reminders every twenty-four hours until the fellow enters an annotation for the study report.

The academic fellow electrophysiologist logs into application server computer system via a remote client computer over the internet. The Fellow reviews study report and the annotation of EKG technician and inputs comments in a scrollable text box, which are saved to the database. The fellow then assigns an attending physician to review and finalize the study.

Alternatively, an academic fellow electrophysiologist is not used, and the EKG technician assigns the study report directly to the attending physician.

The system notifies the attending physician by e-mail, SMS text messaging, pager, et cetera, that the study awaits review. The attending physician logs in to application server computer system over internet, reviews the study report and the annotations of both the EKG technician and the academic fellow electrophysiologist, if any, analyzes the information, and enters his final analysis into a scrollable text box. The attending physician's final report is saved to the database.

The application server computer system automatically generates a referral letter based on study report and the final comments of attending physician, which is forwarded to referring physician, by e-mail or facsimile, for example. Once the study has been finalized, the system notifies the EKG technician by e-mail, SMS text messaging, pager, et cetera, that the final report is complete.

At the completion of a monitoring period, the system automatically generates a summary report, posting it to the patient record and forwarding it to referring physician. The EKG review system also generates a billing report and sends it to the billing department for final client billing.

### BRIEF DESCRIPTION OF THE DRAWINGS

The invention is described in detail hereinafter on the basis of the embodiments represented in the accompanying figures, in which:

FIG. 1 is a schematic diagram that illustrates the structure of a typical EKG review system according to an embodiment of the invention, showing a plurality of client computers in communication with an application server computer system over a network;

FIG. 2 is a functional block diagram of the application server computer system of FIG. 1, showing the various software components that provide system functionality to carry out an EKG review method according to a preferred embodiment of the invention;

FIG. 3 is a flow chart diagram that illustrates a typical sequence for communicating between one of the plurality of client computers and the application server computer system of FIG. 1;

FIG. 4 is a flow chart diagram that illustrates an EKG review method according to a preferred embodiment of the invention, showing steps performed directly by the application server computer system of FIGS. 1-2, including the coordination of actions of various human actors;

FIG. 5 is a detailed flow chart diagram of the EKG routing and analysis step of the EKG review method of FIG. 4, showing steps performed by the application server computer system of FIGS. 1-2, including the coordination of actions of various human actors;

FIG. 6 is a depiction of a typical graphical user interface produced by the application server computer system of FIGS. 1-2 with fields for entry of patient and demographic data, which is presented to a patient during enrollment into a cardiac monitoring service according to an embodiment of the invention;

FIG. 7 is a depiction of a typical graphical user interface produced by the application server computer system of FIGS. 1-2 according to a preferred embodiment of the invention, which is presented to an EKG technician, an academic fellow electrophysiologist, and an attending physician for review and analysis of a cardiac event monitor EKG;

FIG. 8 is a depiction of a typical graphical user interface produced by the application server computer system of FIGS. 1-2 according to an embodiment of the invention, which is presented to an EKG technician, an academic fellow electrophysiologist, and an attending physician for review and analysis of a holter monitor EKG; and

FIG. 9 is a depiction of a typical graphical user interface produced by the application server computer system of FIGS. 1-2 that is presented to an EKG technician and optionally to an academic fellow and/or attending physician showing a listing and status of current cardiac monitoring studies and graphical controls for assigning a cardiac study report to others for review.

### DESCRIPTION OF THE PREFERRED EMBODIMENT OF THE INVENTION

According to a preferred embodiment of the invention, a business method for the review of electrocardiograms (EKGs) may be implemented or facilitated by a custom client-server system that is arranged and designed to route cardiac data for review by first, an EKG technician, second, an academic fellow electrophysiologist, and finally, an attending physician, for superior and more timely analyses of EKGs. In an alternative embodiment, use of an academic fellow electrophysiologist is optional. The client server system functions as a web-enabled software portal that is accessible by patients, referring physicians, EKG technicians, cardiac monitoring services, attending physicians, and academic fellows, which, in addition to providing access to EKGs and promulgating review notifications, automatically generates written reports and correspondence and attends to billing and logistical matters related to EKG review.

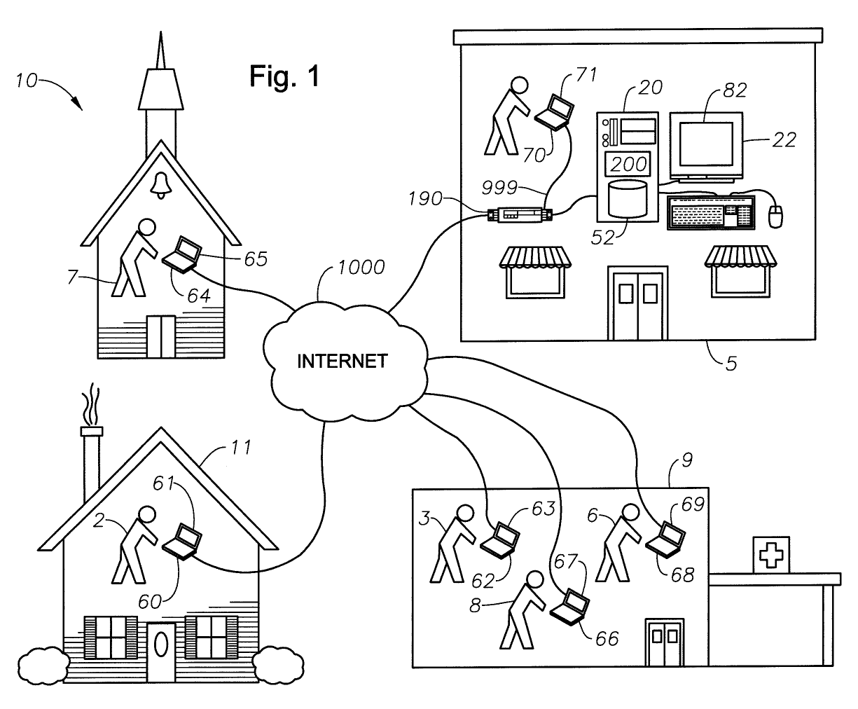

FIG. 1 is an upper level schematic diagram that illustrates the EKG management system 10 according to a preferred embodiment of the invention. The EKG management system 10 preferably includes a high-capacity application server computer system 20 that hosts a custom software suite 200 for selectively and securely allowing client computers 60, 62, 64, 66, 68, 70 access to the server over a network 999, 1000 for use in routing and analyzing cardio data.

Application server computer system 20 is preferably operated by a monitoring service provider 5, which receives raw cardio data from electrocardiographs, performs technical analyses, and creates reports that are provided to the referring physician. Monitoring service providers may or may not include turn-key services such as providing recorders and patient hook-ups by EKG technicians. Monitoring service provider 5 typically provides services to a large number of physicians and medical facilities to create efficiencies resulting from economy of scale.

Application server computer system 20 preferably includes functionality to protect one medical service provider's data from another and the ability to customize the functionality and user interface for each medical service provider.

Application server computer system 20 and client computers or workstations 60, 62, 64, 66, 68, 70 may be any of personal computers, workstation computers, laptop computers, handheld computers, minicomputers, mainframes, or other types of computers, as appropriate. Client computers 60, 62, 64, 66, 68, 70 may also be wireless personal digital assistants (PDAs) such as BlackBerry,® Palm® or iPhone® handheld devices or cell phones that communicate with EKG review system 10 via a wireless internet connection.

As is well known in the computer field, each computer system 20, 60, 62, 64, 66, 68, 70 contains one or more processors which execute instructions retrieved from a memory device to control the reception and manipulation of input data, the transfer of data to other computers, and the output and display of data on output devices. Typically, a memory bus is used by the processor(s) to access random access memory (RAM), read only memory (ROM), or other memory. Memory is used for storing input data, processed data, and software in the form of instructions for the processor(s). The computers typically employ one or more peripheral buses to access input, output and storage devices, such as display monitors, floppy disk drives, compact disc drives (e.g. CD-ROMs), hard disk drives, input keyboards, mice, printers, universal serial bus (USB) memory devices, and network interfaces.

Each computer system 20, 60, 62, 64, 66, 68, 70 includes an operating system such as Linux,® Unix,® Windows,® or Macintosh® operating system to control computer resources and peripherals and the execution of software computer code. The software code may reside in part or in entirety in RAM, ROM, a hard disk drive, a CD-ROM, a floppy drive or other storage medium. Additionally, the software code may be stored at a separate computer and accessed over a network. As this general computer technology is commonplace and well understood in the art, it is not discussed further herein.

The application server computer system 20 is preferably a high-capacity computer web server system, of at least one but possibly multiple computers, depending on the required capacity for concurrent client connections, which runs EKG manager software suite 200. Preferably, the ability to provide internet connections employing SSL encryption is provided, and the website produced by application server computer system 20 is ideally HIPAA compliant.

In a preferred embodiment, application server computer system 20 is ideally sufficiently capable to support several hundred concurrent client connections. Application server computer 20 functions by listening for connections made by authorized client computers 60, 62, 64, 66, 68, 70 and by transmitting data between computers over a network 999, 1000 according to the programmed logic of EKG manager software suite 200. Software suite 200 includes a database 52 for storing patient data, EKGs, interpretation reports, et cetera. Database 52 system preferably uses a relational database management system (RDBMS). Application server computer system 20 also functions as a database server for database 52.

Application server computer 20 is connected to an external network 1000, preferably the internet, by a high-bandwidth connection, so that remote clients 60, 62, 64, 66, 68 can access the EKG review system. Application server computer system 20 may also host one or more local client computers 70 on a local network 999 as appropriate. For instance, if application server computer system is located at a cardiac monitoring service provider's office, a service provider technician may access the EKG review system 10 via computer 70 over local network connection 999.

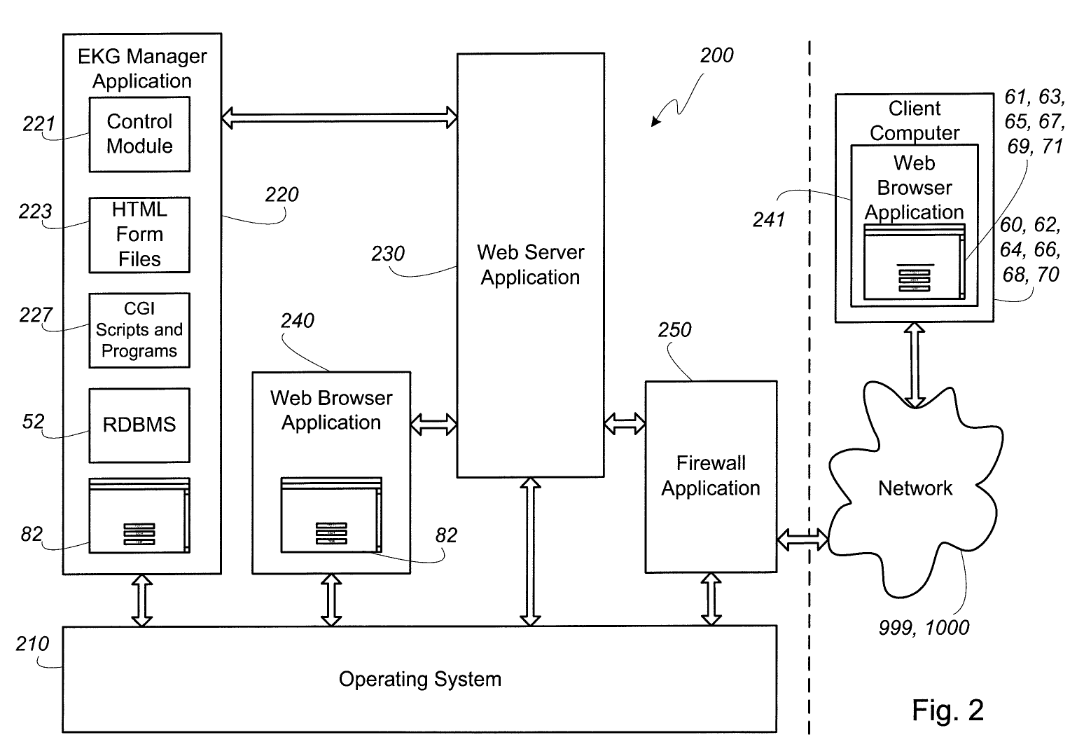

EKG management system 10 includes application software suite 200 as an integral part of the system. Software suite 200 provides the functionality to implement the EKG analysis and routing functions according to a preferred embodiment of the invention. Software suite 200 also manages patient data and billing matters pertaining to cardiac monitoring services. FIG. 2 is a functional block diagram of a preferred embodiment of software suite 200. Computer software suite 200 includes an operating system 210, a web server application 230, an optional web browser application 240, an optional network firewall application 250, and a custom EKG manager module 220.

Operating system 210 controls computer resources, peripherals, and the execution of software applications for each computer in server system 20. Operating system 210 is preferably an industry-standard operating system such as a Linux,® Unix,® Windows,® or Macintosh® operating system. As operating system technology is commonplace and well understood in the art, operating system 210 is not discussed further herein.

Software suite 200 includes a web sever application 230 that enables users at client computers 60, 62, 64, 66, 68, 70 to access selected portions of EKG management system 10 to upload and download or otherwise access EKG's, analyses, et cetera. Apache® is a popular open source HyperText transport protocol (HTTP) web server application that is used with Linux,® Windows® and other operating systems. Utilizing standard Ethernet and TCP/IP networking protocols, EKG management system 10 is connected to the internet 1000 and assigned a static internet protocol (IP) address enabling direct inbound communication from anywhere in the world having internet access. As web server applications are commonplace and well known in the art, web server application 230 is not discussed further herein.

EKG review system 10 may include a network firewall to protect it from unauthorized intrusion and computer hacking efforts. The firewall may be a firewall software application 250 executed by application server computer system 20, or it may be a discrete and independent hardware firewall 190 (FIG. 1) operatively coupled between the network interface of application server computer system 20 and internet 1000. Regardless of the type of firewall installed, the firewall is preferably commercial off-the-shelf and provides controlled access to EKG review system 10 using multiple recognized network security methods such as user and password challenges, VPN access, filtered IP address access, et cetera. As network firewalls are well known in the art, firewall 190, 250 is not discussed further herein.

Software suite 200 may include a standard web browser application 240 such as Internet Explorer® or Netscape Navigator® that displays as a web page HyperText mark-up language (HTML) code generated concurrently by EKG manager module 220 and web server application 230.

EKG manager module 220 is a custom software application that generates a local user display 82 on server computer system 20 and generates various web-enabled computer displays 61, 63, 65, 67, 69, 71 on client computers 60, 62, 64, 66,.68, 70, which are adapted for patients 2, referring physicians 3, academic fellows 7, attending physicians 8, EKG technicians 6 and technicians of monitoring service provider 5, respectively. EKG manager module 220 also routes EKGs and reports over the network 999, 1000 to client computers 60, 62, 64, 66, 68, 70, sends notices and reminders to the client computers, and accepts control commands over the network 999, 1000 from the client computers for use of the system.

EKG manager software application 220 preferably includes a logic control module 221, a family of hyperlinked HTML form files 223 disposed in a web page directory accessed by web server application 230, and a series of Common Gateway Interface (CGI) shell scripts or compiled programs 227, disposed in a cgi-bin directory, that are selectively executed in order to transform the otherwise static HTML form files 223 into a dynamic user interface when displayed in a web browser. A relational database application 52, such as MS-SQL,® is preferably integrated with EKG manager module 220 in order to simplify the handling of the large amount of collected cardio and patient data. As relational databases are well known in the art, database 52 is not discussed further herein.

Management and access to EKG review system 10 for system administration is preferably provided at user interface 82 on monitor 22 (FIG. 1) of application server computer system 20. Software suite 200 generates local user interface 82, which is preferably a graphical user interface (GUI) constructed of standard windows-type display and control mechanisms including windows, client windows, frames, icons, buttons, check boxes, radio buttons, scroll bars, drop-down menus, pull-down menus, folder tabs, bar graphs, panes, panels, forms, slide bars, selection boxes, dialog boxes, text boxes, list boxes, menu bars, bar graphs, wizards, grids, et cetera. The graphical user interface may be programmed using an object-oriented programming language such as C++ for a Microsoft® Windows,® Linux® or Unix® operating system. In a first embodiment, graphical user interface 82 is generated directly by EKG manager module 220 (using operating system 210 resources as appropriate), and in a second embodiment, graphical user interface 82 is provided by web browser 240 displaying HTML files generated by EKG manager module 220 and web server application 230. As user interface and object-oriented programming is well known in the field, the details of constructing the user interfaces are not discussed further herein.

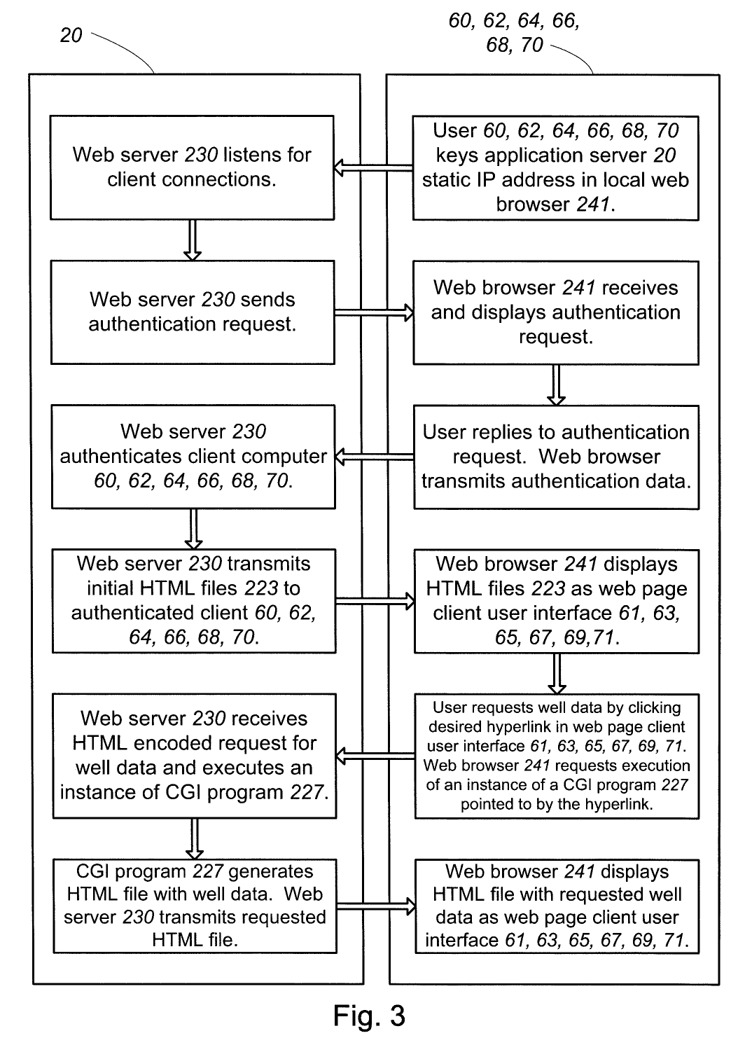

FIG. 3 is a flow chart diagram illustrating an example communication sequence between a client computer 60, 62, 64, 66, 68, 70 and application server computer system 20. Referring to FIGS. 2 and 3, web server application 230 and EKG manager module 220 cooperate to provide secure remote access to EKG review system 10. Web server 230 provides initial login access to client computer 60, 62, 64, 66, 68, 70. Once the client computer is authenticated, an initial or default HTML file 223 is transmitted by web server 230 to the client computer. The contents of the initial HTML file 223 preferably varies, depending on whether it is a patient, a monitoring service technician, an EKG technician, a referring physician, an attending physician, or an academic fellow who has logged on to application server computer system 20.

Web server 230 fields requests from remote users via one or more HTML web pages 223. EKG manager module 220 interprets each request using CGI scripts or programs 227 and selects, analyzes, sorts and codes patient, demographic and cardio data in HTML format in response to the request. Web server 230 transmits the generated HTML code over network 999, 1000 to client computer 60, 62, 64, 66, 68, 70 for display in a web browser application 241 running thereon. Thus, the client user interface 61, 63, 65, 67, 69, 71 display preferably consists entirely of HTML code displayed in a browser software application running on the client computer system 60, 62, 64, 66, 68, 70, respectively. Data reports, generated by EKG manager module 220 or produced by EKG technician, monitoring service technician, attending physician or academic fellow in Word,® Excel,® Adobe® Acrobat,® or Crystal Reports® format for example, may be uploaded or downloaded by client computer 60, 62, 64, 66, 68, 70 via web server 230.

EKG review system 10 is additionally programmed to “push” data to a remote user, rather than being limited to responding to a user request that “pulls” data. For instance, cardiac study report notices are automatically and routinely generated and emailed to EKG technician 6. Also, situations where uploaded cardio data exceeds notification criteria may be immediately communicated in real-time to requesting physician 3 via pager, email, SMS text messaging, or any other type of internet messaging platform. As internet application programming is well known in the art, details are not provided herein.

Although the embodiments of EKG review system 10 described herein employ HTML and TCP/IP formats, the invention is not limited to using these formats. New communication formats and protocols may be developed over time which may replace existing formats, and EKG review system 10 preferably employs technologies consistent with the internet standards in use at any given time. For example, HTML extensions, XML and PHP may be used.

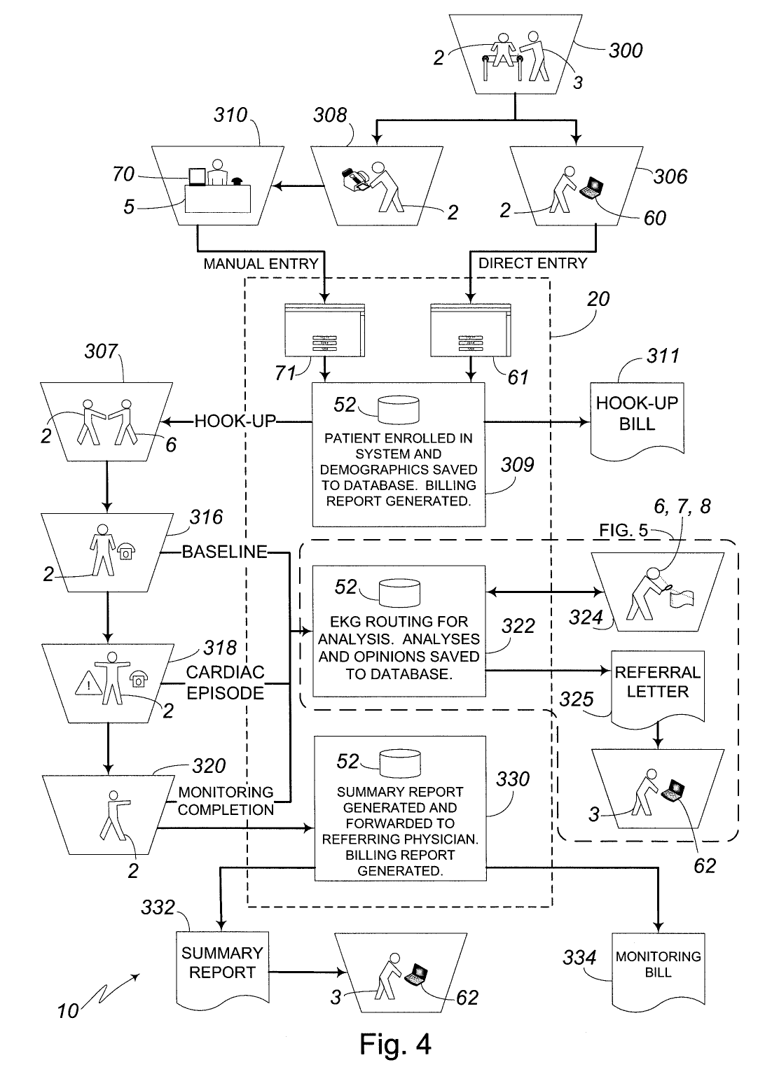

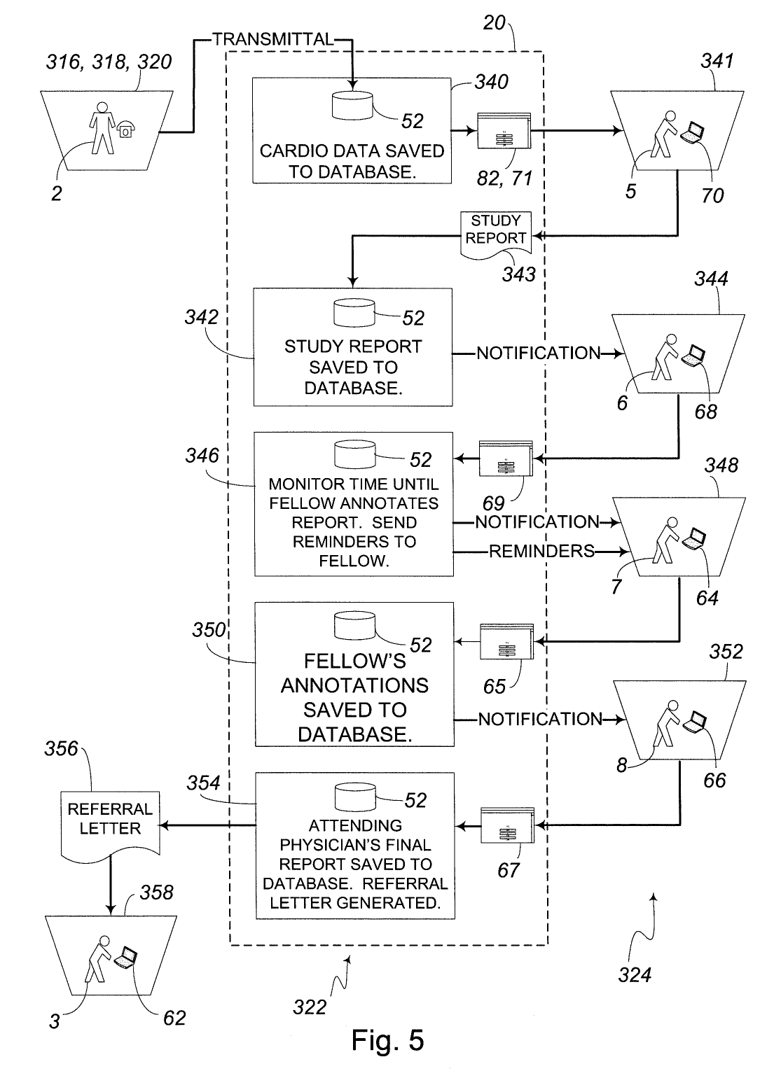

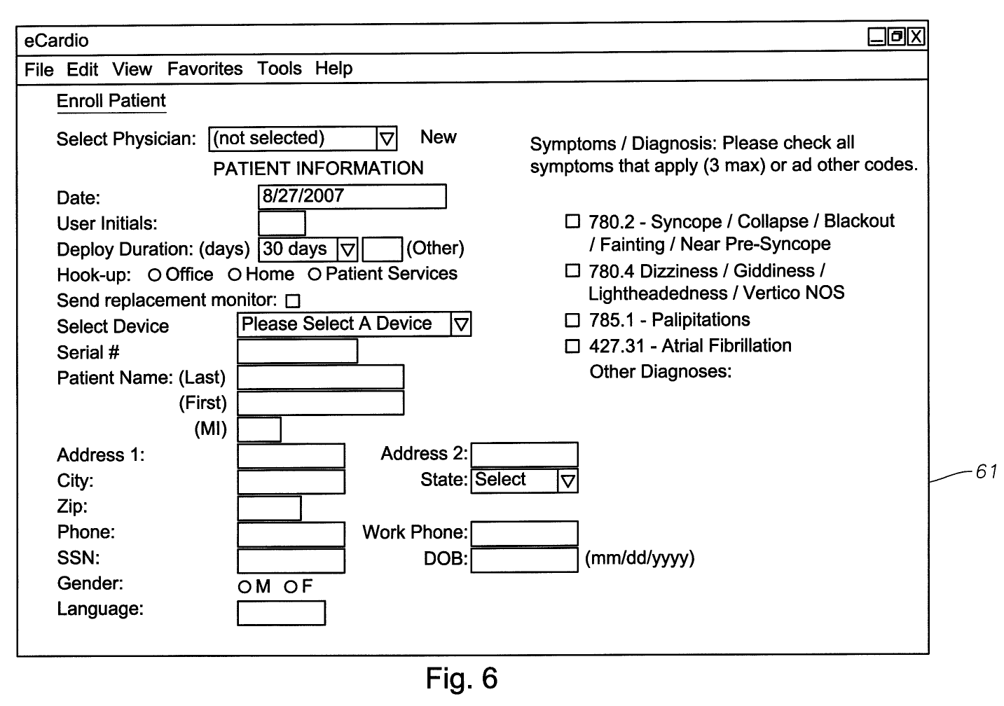

FIGS. 4 and 5 are flowchart diagrams that illustrate a method of EKG review management that is implemented by EKG management system 10 according to a preferred embodiment of the invention. Referring to FIG. 4, as represented by block 300, a patient 2 is examined and a cardiac test, for example holter monitoring or cardiac event monitoring, is ordered by the referring or ordering physician 3. Next, patient 2 is enrolled in a monitoring program operated by a cardiac monitoring service 5 that uses the business method and system for electrocardiogram review 10 according to one or more embodiments of the invention. At step 306, patient 2 enrolls directly into the monitoring program using computer 60 to access application server computer system 20. Via a patient enrollment computer user interface 61 (FIGS. 1, 2 and 6), patient 2 enters various personal and demographic information into database 52 of application server computer system 20. Alternatively, at steps 308 and 310, patient 2 may fax an enrollment form to the monitoring service provider 5, who will keypunch the patient and demographic data into database 52 of application server computer system 20.

Software suite 200 may be programmed so that the enrollment of patient 2 into a monitoring program causes EKG review system 10 to notify an EKG technician 6 that a hook-up of patient 2 is required. EKG technician 6 is typically a client (or employee thereof) of monitoring service provider 5 but alternatively can be employed directly by service provider 5. EKG technician 6 prepares the recorder for the monitoring period, configuring any custom parameters as required. EKG technician 6 may hook up patient 2 at the place of business of monitoring service provider 5, a medical facility 9 (FIG. 1) such as a hospital, clinic or doctor's office, or the patient's home 11 (FIG. 1). Alternatively, patient 2 may perform a self-hook-up by following instructions provided with the recorder. At step 309, triggered by the hook-up 307 of the monitoring equipment to patient 2, EKG review system 10 automatically generates a client billing report 311 and forwards the report to the monitoring service provider's billing department for billing the patient and/or the patient's insurance provider for the initial monitor hook-up. Patient 2 is then monitored, either outpatient or inpatient.

For cardiac event monitoring using a loop monitoring device, a baseline EKG measurement 316 is typically taken. The raw baseline cardio data are typically transmitted from the recorder to the application server computer system 20 of the monitoring service provider 5 over the telephone network.

The cardiac event monitor is typically worn for about thirty or more days. If patient 2 suffers a cardiac episode, as signified in step 318, patient 2 depresses a record button on the event monitor, which saves the raw cardio data occurring shortly before, during and following the episode. The event monitor may also be automatically triggered to record the cardiac episode. As with the baseline event transmission 316, the episode cardio data are transmitted by the event recorder to the application server computer system 20 over a telephone or wireless network.

For both cardiac event monitoring and holter monitoring, at the completion of the electrocardiograph test, patient 2 returns the recorder, and the raw cardio data are retrieved from the recorder and uploaded to application server computer system 20, either by the telephone/wireless network or by another extraction means at service provider 5. This step is depicted at step 320.

According to step 322, for each of the baseline measurements 316, cardiac episode recordings 318 and test end measurements 320, the cardio data are stored in database 52. The EKG review system 10 then routes the cardio data between one or more EKG technicians 6, academic fellows 7 and attending physicians 8 for analysis 324 as described hereinafter with respect to FIG. 5.

Referring to step 330, uploading the test end event 320 raw cardio data to application server computer system 20 triggers EKG review system 10 to generate a summary report 332, posting the summary report 332 to the patient record and forwarding it to referring physician 3. EKG review system 10 also generates a billing report 334 and sends it to the billing department for final client billing.

Referring to FIG. 5, cardio data transferred from the recorder to application server computer system 20 are written to database 52 at step 340, regardless of whether the data-causing event is a baseline measurement 316, a cardiac episode 318 or the completion of monitoring 320. At step 341, service provider 5 processes the raw cardio data and generates a cardiac study report 343 therefrom (via a client user interface 71 or application server computer system user interface 82). At step 342, study report 343 is written to database 52. If the cardio data or any parameter of study report 343 exceeds a notification criteria, the protocol for that patient is followed. EKG review system 10 then notifies an EKG technician 6, for example, by e-mail, SMS text message, pager, et cetera, that study report 343 has been generated and requires review.

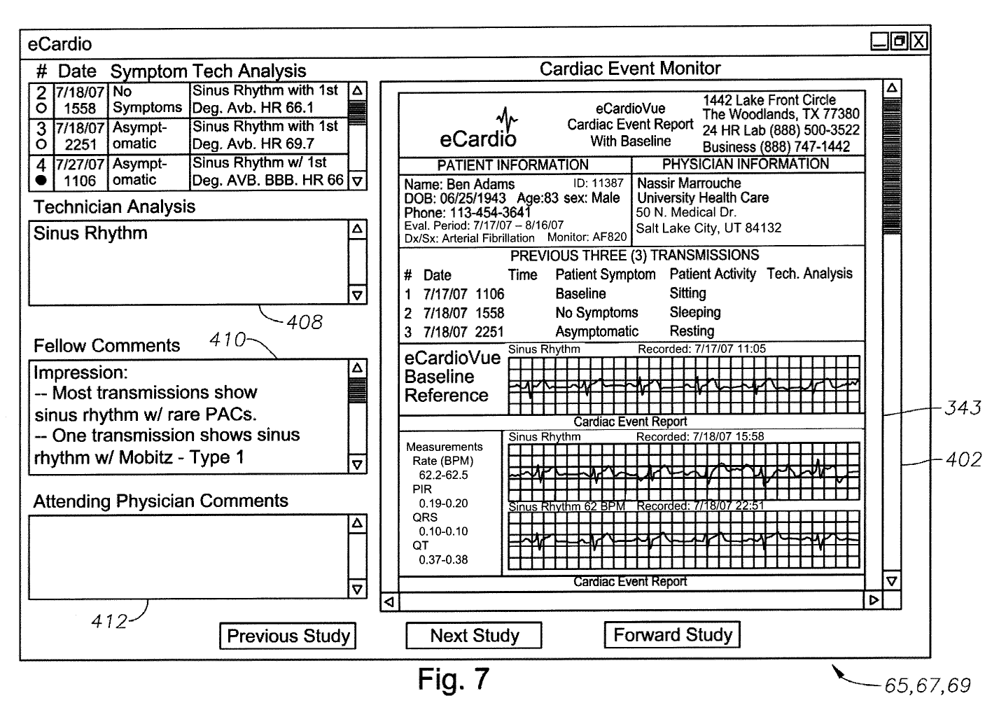

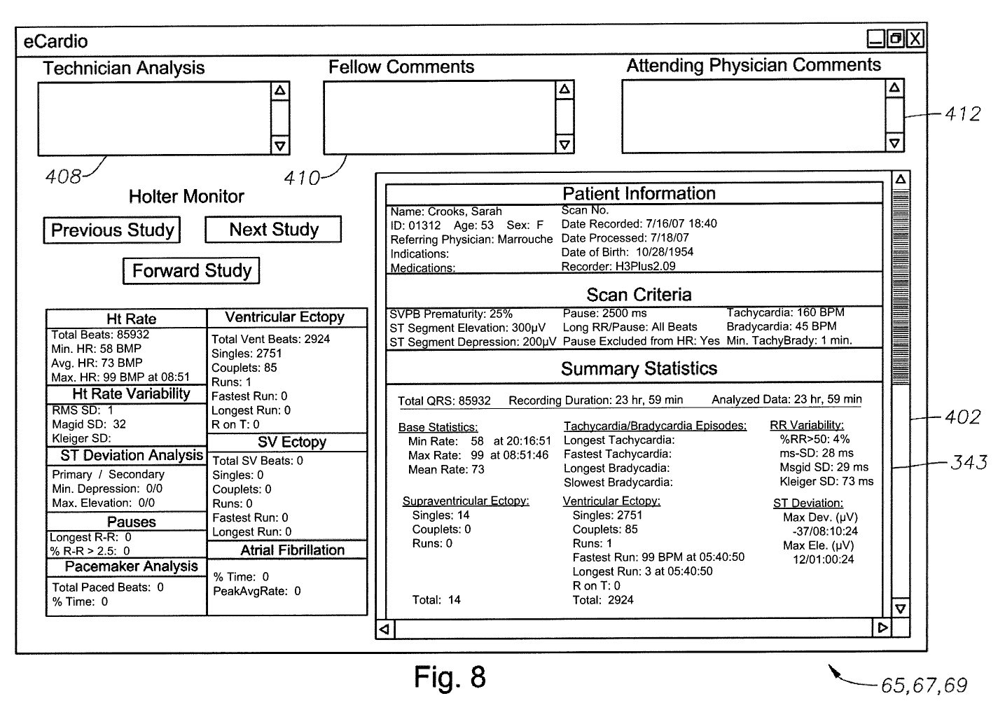

Study report 343 preferably includes cardio data and the patient and demographic data provided by patient 2 during enrollment. FIGS. 7 and 8 depict typical user interfaces 64, 66, 68 that include scrollable text windows 402 for displaying study report 343. FIG. 7 shows a typical study report 343 associated with a loop recorder. Cardio data from the baseline measurement 316, if any, all cardiac episode events 318, if any, and the test completion measurement 320 are analyzed by service provider 5. For example, values for heart rate and P-R, QRS and Q-T intervals are displayed. One or more EKG channels are preferably graphically plotted. FIG. 8 shows a typical study report 343 associated with a Holter monitor. Patient data, demographic data and relevant cardio data are similarly displayed.

Referring to FIG. 5, as shown at step 344, EKG technician 6 logs on to application server computer system 20 via client computer 68 for access to patient study report 343. Alternatively, if employed by service provider 5, EKG technician 6 may access application server computer system 20 directly using computer user interface 82 (FIGS. 1-2). EKG technician 6 preferably reviews study report 343 and annotates analytical comments pertaining thereto in text box 408 of user interface 69 (FIGS. 7-8), which are in turn stored in database 52 by application server computer system 20. The comments of EKG technician remain available for viewing but not for editing by the academic fellow electrophysiologist 7 and/or attending physician 8, who subsequently review(s) the study report 343.

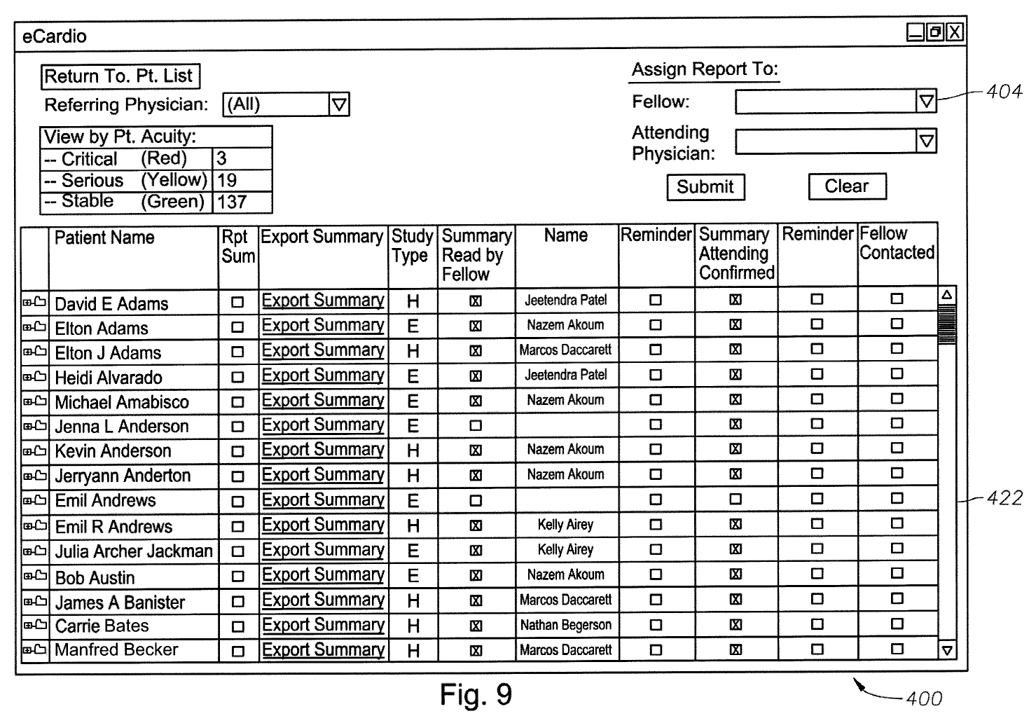

FIG. 9 illustrates an index screen 400 for EKG technician 6 that lists active cardiac monitoring studies with which EKG technician 6 is affiliated. Using graphical feature 404, EKG technician 6 assigns (step 349) study report 343 to academic fellow electrophysiologist 7 for EKG review. As soon as EKG technician 6 assigns study report 343 to academic fellow electrophysiologist 7, application server computer system 20 notifies (step 346) fellow 7 via e-mail, SMS text message, pager, et cetera, that study report 343 requires review. Application server computer system 20 times the interval until fellow 7 enters an annotation for study report 343 and automatically generates and sends reminders via e-mail, SMS text message, pager, et cetera, to fellow 7 every twenty-four hours until fellow 7 enters an annotation for study report 343.

At step 348, academic fellow electrophysiologist 7 logs into application server computer system 20 via remote client computer 64 and internet 1000. Fellow 7 reviews study report 343 and the annotation of EKG technician 6 via user interface 65 (FIGS. 7-8). Study report 343 is viewable in scrollable text box 402, and the EKG technician's annotation is viewable in scrollable text box 408. Fellow 7 analyzes the information and inputs comments in scrollable text box 410.

At step 350, when fellow 7 has entered an annotation in text box 410, application server computer 20 saves the contents to database 52 and ceases to send reminders to fellow 7. In a first embodiment of the invention, fellow 7 assigns attending physician 8 to review the study 343, and in a second embodiment, EKG technician 6 assigns attending physician to review the study 343. Attending physician 8 is notified by e-mail, SMS text messaging, pager, et cetera, that study 343 awaits review.

At step 352, attending physician 8 logs in to application server computer system 20 via remote client computer 66 and internet 1000. Attending physician 8 reviews study report 343 and the annotations of both EKG technician 6 and academic fellow electrophysiologist 7 via user interface 67 (FIGS. 7-8). Study report 343, the EKG technician's annotation, and the fellow's annotation are viewable in scrollable text boxes 402, 408, and 410, respectively. Attending physician 8 analyzes the information and inputs his final analysis in scrollable text box 412.

At step 354, the attending physician's final report is saved to database 52. Application server computer system 20 automatically generates a referral letter 356 based on study report 343 and the final comments of attending physician 8. The annotations of EKG technician 6 and academic fellow electrophysiologist 7 may optionally be included in referral letter 356. Referral letter 356 is automatically forwarded by application server computer system 20 to requesting physician 3, by e-mail or facsimile, for example. Once referral letter 356 has been generated, application server computer system 20 automatically updates the index 422 of FIG. 9 and notifies EKG technician 6 by e-mail, SMS text messaging, pager, et cetera, that the final report is complete.

At step 358, physician 3 may review referral letter 356 with the attending physician's diagnosis and comments and thus attend to patient 2 accordingly.

FIG. 9 illustrates a index screen 400 which may be used by EKG technician 6, and optionally be fellow 7 and/or attending physician 8. The screen includes a table 422 that allows one to see the status of all pending studies, including who has been assigned to review each study and the status of the reviews. The listing can be ordered by severity of the patients' conditions, which are preferably shown by color coding of the data.

Although EKG review system 10 is described herein as having an applications server computer system 20 that is located at and/or operated by a monitoring service provider 5, the invention is not so limited. According to another embodiment, any business entity may operate and maintain one or more applications server computer systems, as described hereinabove, that may serve anywhere from a single medical care provider to a number of monitoring service providers each serving many medical care providers.

The present invention may be embodied in part as computer readable code on computer readable media, including any computer data storage device such as magnetic storage devices, optical storage devices or ROM storage devices. The computer readable code may also be distributed over a network between computer systems so that it is stored and executed in a distributed fashion.

The Abstract of the disclosure is written solely for providing the United States Patent and Trademark Office and the public at large with a way to determine quickly from a cursory reading the nature and gist of the technical disclosure, and it represents solely a preferred embodiment and is not indicative of the nature of the invention as a whole.

While some embodiments of the invention have been illustrated in detail, the invention is not limited to the embodiments shown; modifications and adaptations of the above embodiment may occur to those skilled in the art. Such modifications and adaptations are in the spirit and scope of the invention as set forth herein:

1. A method for review and analysis of electrocardiograms comprising the steps of:
establishing an application server computer system arranged for storing, displaying, manipulating and transferring cardio data and patient data;
operatively connecting said application server computer system with a first client computer that is disposed in proximity to an electrocardiograph technician;
operatively connecting said application server computer system with a second client computer that is disposed in proximity to an attending physician;
uploading from an electrocardiograph a first set of raw cardio data to said application server computer system;
processing said cardio data into a study report;
storing said study report by said computer system;
notifying said electrocardiograph technician by said application server computer system that said study report exists;
receiving by said application server computer system a review by said electrocardiograph technician of said study report via said first client computer;
storing a first annotation of said electrocardiograph technician regarding said study report by said application server computer system;
receiving by said application server computer system a review by said attending physician of said study report via said second client computer; and
storing a second annotation of said attending physician regarding said study report by said application server computer system.

2. The method of claim 1 further comprising the steps of:
operatively connecting said application server computer system with a third client computer that is disposed in proximity to an academic fellow electrophysiologist;
receiving by said application server computer system a review by said academic fellow electrophysiologist of study report via said third client computer;
storing a third annotation of said academic fellow electrophysiologist regarding said study report by said application server computer system.

3. The method of claim 2 further comprising the steps of:
assigning by said electrocardiograph technician said academic fellow electrophysiologist to review said study report via said first client computer and said application server computer system; and
notifying said academic fellow electrophysiologist by said application server computer system of said assignment.

4. The method of claim 2 further comprising the steps of:
automatically generating by said application server computer system a referral letter based on said study report and said third annotation; and
automatically forwarding by said application server computer system said referral letter to a referring physician.

5. The method of claim 2 further comprising the steps of:
automatically generating by said application server computer system a reminder message; and
automatically forwarding by said application server computer system said reminder message to said academic fellow electrophysiologist via said third client computer.

6. The method of claim 2 further comprising the steps of:
operatively connecting said application server computer system with a fourth client computer that is disposed in proximity to a patient; and
receiving by said application server computer system patient data input by said patient via said fourth client computer.

7. The method of claim 2 further comprising the step of:
displaying by said application server computer system a listing of a plurality of study reports sorted by order of severity.

8. A business method for review and analysis of electrocardiograms comprising the steps of:
establishing an application server computer system arranged for storing, displaying, manipulating and transferring cardio and patient data;
allowing said application server computer system to be accessed by one or more remote computers over a network;
receiving by said application server computer system a first set of raw cardio data from an electrocardiograph;
storing a study report based on said first set of raw cardio data by said application server computer system;
notifying an electrocardiograph technician by said application server computer system that said study report exists;
providing access of said study report to said electrocardiograph technician via said network by said application server computer system;
receiving by said application server computer system a first annotation from said electrocardiograph technician;
storing by said application server computer system said first annotation;
notifying an academic fellow electrophysiologist by said application server computer system that said study report exists;
providing access of said study report and said first annotation to said academic fellow electrophysiologist via said network by said application server computer system;
receiving by said application server computer system a second annotation from said academic fellow electrophysiologist;
storing by said application server computer system said second annotation;
notifying an attending physician by said application server computer system that said study report exists;
providing access of said study report, said first annotation and said second annotation to said attending physician via said network by said application server computer system;
receiving by said application server computer system a third annotation from said attending physician; and
storing by said application server computer system said third annotation.

9. The business method of claim 8 further comprising the steps of:
receiving by said application server computer system from said electrocardiograph technician an assignment designation of said academic fellow electrophysiologist; and
notifying said academic fellow electrophysiologist of said assignment designation.

10. The business method of claim 8 further comprising the steps of:
automatically generating by said application server computer system a referral letter based on said study report and said third annotation; and
automatically forwarding by said application server computer system said referral letter to a requesting physician.

11. The business method of claim 8 further comprising the steps of:
automatically generating by said application server computer system a reminder message; and
automatically forwarding by said application server computer system said reminder message to said academic fellow electrophysiologist via said network.

12. The business method of claim 8 further comprising the steps of:
receiving by said application server computer system patient data input by a patient via said network.

13. The business method of claim 8 further comprising the step of:
displaying by said application server computer system a listing of a plurality of study reports sorted by order of severity.

14. A system for review and analysis of electrocardiograms comprising:
an application server computer system arranged for storing, displaying, manipulating and transferring cardio and patient data;
means for accessing said application server computer system by one or more remote computers over a network;
means for receiving by said application server computer system a first set of raw cardio data from an electrocardiograph;
means for receiving by said application server computer system a study report based on said first set of raw cardio data;
means for notifying an electrocardiograph technician by said application server computer system that said study report exists;
means for providing said study report to said electrocardiograph technician via said network;
means for receiving by said application server computer system a first annotation from said electrocardiograph technician via said network;
means for notifying an attending physician by said application server computer system that said study report exists;
means for providing said study report and said first annotation to said attending physician via said network; and
means for receiving by said application server computer system a second annotation from said attending physician via said network.

15. The system of claim 14 further comprising:
means for notifying an academic fellow electrophysiologist by said application server computer system that said study report exists;
means for providing said study report and said first annotation to said academic fellow electrophysiologist via said network;
means for receiving by said application server computer system a third annotation from said academic fellow electrophysiologist via said network; and
means for providing said third annotation to said attending physician via said network

16. The system of claim 15 further comprising:
means for assigning via said network by said electrocardiograph technician said academic fellow electrophysiologist to review said study report

17. The system of claim 15 further comprising:
means automatically generating by said application server computer system a referral letter based on said study report and said third annotation; and
means for automatically forwarding by said application server computer system said referral letter to a requesting physician.

18. The system of claim 15 further comprising:
means for automatically generating by said application server computer system a reminder message; and
means for automatically forwarding by said application server computer system said reminder message to said academic fellow electrophysiologist via said network.

19. The system of claim 15 further comprising:
means for receiving by said application server computer system patient data input by said patient via said network.

20. The system of claim 15 further comprising:
means for displaying by said application server computer system a listing of a plurality of study reports sorted by order of severity.
